(19) United States
(12) Patent Application Publication
(10) Pub. No.: US 2004/0034872 A1
(43) Pub. Date: Feb. 19, 2004

(54) Method for triggering an event in an electronic device, and corresponding device

(76) Inventors: Peter Huyge, Elsene (BE); Wouter Delva, Merelbeke (BE); Geert Van den Bossche, Lokeren (BE)

Correspondence Address: JOSEPH S. TRIPOLI, THOMSON MULTIMEDIA LICENSING INC., 2 INDEPENDENCE WAY, P.O. Box 5312, Princeton, NJ, 08543-5312, US

(21) Appl. No.: 10/222,683

(22) Filed: Aug. 16, 2002

(51) Int. Cl. H04N 7/173; G06F 3/00; H04N 5/445; G09G 5/00; H04N 7/16; G06F 13/00

(52) U.S. Cl. 725/111; 725/37; 725/135

(57) ABSTRACT

Method for triggering an event—such as but not limited to a reset to default parameter values—in an electronic device comprising input means responsive to a user input. The method comprising the steps of providing a first period of time during which the user is authorized to activate the input means; in response to a predetermined user input during the first period of time, providing a second period of time, distinct from said first period of time, and during which the user is authorized to activate the user input means; and triggering said event in response to a user input during the second period of time.

### FIELD OF THE INVENTION

The invention concerns a method for controlling an electronic device, and in particular a modem. The invention also concerns such a device.

### BACKGROUND OF THE INVENTION

Certain devices, in particular consumer electronics devices in the personal computer area, require an important amount of configuration in order to function properly in a particular environment. An ADSL modem for example requires numerous parameters depending on a particular service provider or telecom operator. These parameters often differ from standard factory settings.

Nevertheless, under certain conditions, it may be necessary to reset the modem to its factory default settings. For example, a telecom operator help line may instruct the user to reset his modem, so that he can be instructed to overcome a certain configuration problem from a modem state known to the help line. Typically, a device that may require such a reset comprises a specific reset button. Since reprogramming the device after a reset may prove complex, undesired resetting should be avoided. For this purpose, the reset button is often placed in a location that is difficult to reach, e.g. inside the device's housing. Activating the button requires opening the housing, or inserting an object through an opening of the housing. This is impractical for a device that is connected by several cables to other devices, such as a personal computer, a telephone line, a television decoder, . . . since resetting the devices most often requires removing the cables first.

Other reset solutions comprise activation of several buttons at the same time, or following a particular sequence. Still, the danger of an undesired activation of the reset remains.

### BRIEF SUMMARY OF THE INVENTION

The invention concerns a method for triggering an event in an electronic device comprising input means responsive to a user input, said method comprising the steps of providing a first period of time during which the user is authorized to activate the input means; in response to a predetermined user input during the first period of time, providing a second period of time, distinct from said first period of time, and during which the user is authorized to activate the user input means; and triggering said event in response to a user input during the second period of time.

In order to trigger the event, e.g. a reset of parameter values to factory default values, the user has to act first during a first time period, in order to call into existence a second time period during which he has to act a second time in order to trigger the reset proper. If the user unintentionally activated the input means (e.g. a pushbutton, touch pad . . . ) during the first period, he can still avoid triggering the reset during the second period, by not activating the input means again.

According to an embodiment of the invention, there is a third time period separating the first and second time periods, in order to avoid that an involuntary release and immediate reactivation of the input means by the user be wrongly interpreted.

According to an embodiment of the invention, the device comprises display which indicates to the user that his input is authorized, e.g. during the first and second time periods. The display device may be a LED, and the first and second periods characterized by a flashing of the LED, or the display of another pattern, or the display of a particular color or luminosity.

The invention also concerns an electronic device comprising an input means adapted to respond to a user input, a computing circuit for executing a program and a memory for storing said program, wherein said computing circuit, during execution of said program, is adapted to provide a first time period of responsiveness of the input means to a predetermined user input, and a second time period of responsiveness of the input means to a predetermined user input, wherein said second time period is provided only in response to a user input during the first time period, and wherein said computing device is further adapted to execute a reset-type procedure of the device in response to a predetermined user input during the second time period.

### BRIEF DESCRIPTION OF THE DRAWINGS

FIG. 1 is a block diagram of an ADSL modem according to the present embodiment of the invention.

FIG. 2 is a chronological diagram of the different control periods and button functions of the pushbutton of FIG. 1.

### DETAILED DESCRIPTION OF THE INVENTION

The embodiment of the invention concerns an asymmetric digital subscriber (ADSL) line modem. The invention is not limited to this particular embodiment, and can be applied to other types of devices.

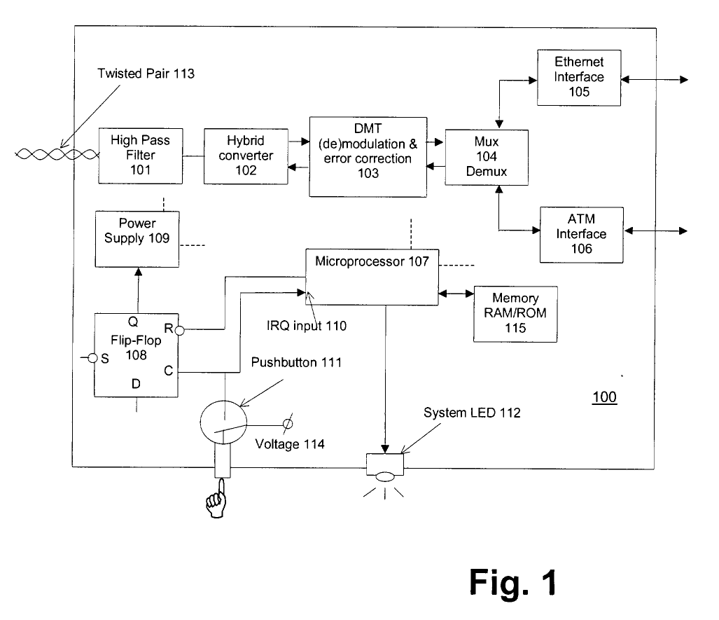

FIG. 1 is a schematic block diagram of a modem 100. The modem comprises a high pass filter 101, a hybrid converter 102, a modulator/demodulator/error correction circuit 103, a network processor 104, and Ethernet interface 105 and an ATM interface 106.

The high pass filter 101 is connected to a twisted pair 113 of a public switched telephone network (PSTN). It separates voice frequencies from digital data carrying frequencies, as is well known in ADSL modems. The hybrid converter circuit 102 carries out a two-to-four wire conversion, separating upstream and downstream traffic. For upstream traffic, circuit 103 performs modulation, Reed Solomon forward error correction redundancy data calculation and trellis coding, while the inverse operations are carried out for downstream traffic. The network processor 104 respectively multiplexes/demultiplexes packets from each of the Ethernet and ATM interfaces 105 and 106, again depending on the direction of the traffic. The interfaces 105 and 106 are connected to appropriate networks or devices (not shown).

Modem 100 further comprises a microprocessor 107, connected to a flip-flop circuit 108. Microprocessor 107 controls a reset input ‘R’ of flip-flop 108. An input ‘C’ of the flip-flop 108 and an interrupt request line 110 of the microprocessor 107 are both connected to a monostable pushbutton 111, operable by user. When pushed, pushbutton 111 connects a voltage source to input ‘C’ and to the interrupt request line 110. Input ‘D’ of the flip-flop is always at value ‘1’. Output ‘Q’ of the flip-flop controls on/off status of power supply 109 through a power FET (not shown), which powers the modem circuits. Microprocessor 107 is also connected to a memory 115, including both volatile and non-volatile memory and for simplicity shown as a single circuit in FIG. 1. Memory 115 contains the program code run by microprocessor 107, and in particular the program code implementing the reset process described below. Lastly, the microprocessor controls a two-color (orange/green) LED 112 for conveying certain modem status information to the user, as explained below.

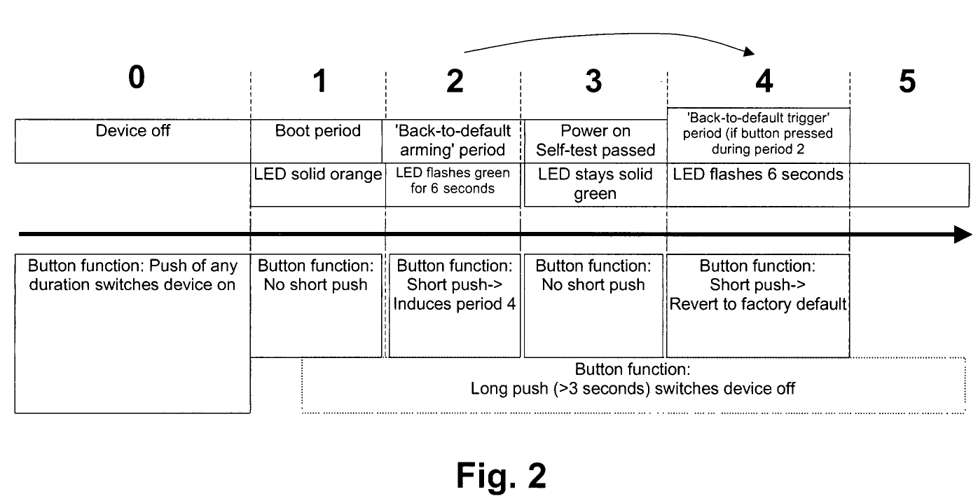

FIG. 2 is a chronological diagram of the state of the modem, starting with the ‘Off’ state (state ‘0’).

Switching the modem on and off is carried out as follows: in the off state, the Q output of flip-flop 108 is at 0. Pressing the button for any duration will shift the value ‘1’ at input ‘D’ to output ‘Q’, activating the power FET of power supply 109. Output ‘Q’ can be reset to ‘0’ only by microprocessor 107. According to the present embodiment, except for part of the boot procedure following switch-on, i.e. during internal hardware checks, at any other time during the power on state, pressing button 111 for a time interval of duration greater than x (where x is for example equal to three seconds) will result in the microprocessor resetting the flip-flop, after an appropriate shut-down procedure. The shutdown procedure comprises sending a message (called ‘Dying Gasp’) to the operator to enable him to distinguish between a normal shutdown (‘Dying Gasp’ present) and an abnormal shutdown (‘Dying Gasp’ absent, e.g. when a connector is remove or a cable is physically severed).

In what follows, pushing button 111 for less than ‘x’ will be called a ‘short push’, while pressing the button for a duration equal or longer than ‘x’ will be called a ‘long push’.

When the modem is switched on, it enters into state ‘1’, the so-called boot period. Certain hardware and software checks are carried out during this period. Moreover, the modem's internal software is checked and readied for execution. As mentioned above, during part of period ‘1’, a long push will have no effect. During the entire boot period, a short push will not have any effect either. (According to a variant of the embodiment, a long push turns the modem off only during or after phase 3).

This period is characterized by a particular signal from the LED, in this case a continuous orange light.

Once the boot procedure has been performed, the user is given the opportunity to ‘arm’ the modem through a short push, during a period ‘2’, identified by a flashing green LED. Period ‘2’ lasts enough time for the user to action the pushbutton, e.g. six seconds, or until the user pushes the button. If the user seizes the opportunity to arm the modem, then the back-to-default period ‘4’ will be present in the sequence of periods; else it will be omitted. In other words, the user has to take positive action to generate the existence of a reset possibility later on. Pressing the pushbutton during the period ‘2’ is not in itself sufficient to reset the modem, and will require further positive action by the user during a predetermined period later on.

After period ‘2’ times out or after the pressed the pushbutton, period ‘3’—called the self-test period—consists giving feedback to the user concerning checks carried out during period ‘1’. Performing a short push will have no influence on the modem. The period lasts about six seconds and is identified by a continuously green system LED.

As mentioned above, period ‘4’—called the ‘back-to-default trigger’ period—only exists if the user pressed the pushbutton for a short duration during period ‘2’. Else, the modem directly enters period ‘5’. During period ‘4’, the LED displays green flashes, as during period ‘2’, to convey to the user the need of an (optional) input from his part. If the user pushes button 111 for a short duration during period ‘4’, the modem will be reset to factory default values. Period ‘4’ lasts for about six seconds, or until the pushing of the button 111. If the user pushes the button, then the fact that the reset is being carried out is acknowledged by flashing all other LEDs of the modem, in addition to the system LED. Note that only the system LED is shown on FIG. 1.

During period ‘5’, the powered-on modem functions with either the default settings if the user carried out the reset procedure, or with the previously programmed settings. During period ‘5’, the system LED displays a continuously green light.

What is claimed is:

1. Method for triggering an event in an electronic device (100) comprising input means (111) responsive to a user input, said method comprising the steps of:
providing a first period of time (2) during which the user is authorized to activate the input means;
in response to a predetermined user input during the first period of time, providing a second period of time (4), distinct from said first period of time, and during which the user is authorized to activate the user input means,
triggering said event in response to a user input during the second period of time.

2. The method according to claim 1, wherein the event is a reset procedure of at least one parameter value of the device.

3. The method according to claim 1, further comprising the step of identifying the first and second periods by displaying, during a respective period, information indicative of the respective period.

4. The method according to claim 2, further comprising the step of placing the first period of time after a start-up procedure of the device.

5. The method according to claim 1, comprising the step of placing a third period of time between the first and second periods of time.

6. The method according to claims 4 and 5, further comprising the step of displaying device status information further to the start-up procedure during the third period of time.

7. The method according to claim 2, further comprising the step of having the device use a default value of at least one parameter in the case the reset procedure was performed, and of having the device use a previously programmed value of at least one parameter in case the reset procedure was not performed.

8. The method according to claim 1, wherein the device is a modem.

9. Electronic device (100) comprising an input means (111) adapted to respond to a user input, a computing circuit (107) for executing a program and a memory (115) for storing said program, wherein said computing circuit, during execution of said program, is adapted to provide a first time period of responsiveness of the input means to a predetermined user input, and a second time period of responsiveness of the input means to a predetermined user input, wherein said second time period is provided only in response to a user input during the first time period, and wherein said computing device is further adapted to execute a reset-type procedure of the device in response to a predetermined user input during the second time period.

10. The electronic device according to claim 9, wherein the input means are connected to an interrupt line of the computing circuit for providing a signal from the input means to the computing circuit when the input means is operated, and wherein the input means is further connected to a power supply.

11. The electronic device according to claim 9, further comprising display means for displaying specific information during said first and second time periods for enabling a user to identify the first and second time periods compared to other time periods.
